(19) United States
(12) Patent Application Publication
(10) Pub. No.: US 2013/0023632 A1
(43) Pub. Date: Jan. 24, 2013

(54) CATALYST SYSTEM BASED ZIRCONIUM

(71) Applicants: Sandor NAGY, Naperville, IL (US); Karen L. Neal-Hawkins, Cincinnati, OH (US)

(72) Inventors: Sandor NAGY, Naperville, IL (US); Karen L. Neal-Hawkins, Cincinnati, OH (US)

(21) Appl. No.: 13/185,233

(22) Filed: Jul. 18, 2011

(51) Int. Cl. C08F 4/16; C08F 4/18; C08F 4/657

(52) U.S. Cl. 526/90; 502/202; 502/117; 502/169

(57) ABSTRACT

A catalyst system obtainable with a process comprising the following steps:
i) contacting a Zirconium compound of formula (I)

ZrX₄ (I)
wherein X, equal to or different from each other, is a halogen atom, a R, OR, SR, NR₂ or PR₂ group wherein R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radical; or two X groups can be joined together to form a divalent R′ group wherein R′ is a C₁-C₂₀-alkylidene, C₆-C₂₀-arylidene, C₇-C₂₀-alkylarylidene, or C₇-C₂₀-arylalkylidene divalent radical optionally containing heteroatoms belonging to groups 13-17 of the Periodic Table of the Elements; with
one or more boron compounds having Lewis acidity wherein the molar ratio between the boron compound and the compound of formula (I) ranges from 0.9 to 100;
ii) adding the reaction mixture obtained in step i) to a support.

### FIELD OF THE INVENTION

The invention relates to catalyst system comprising a zirconium compounds to be used in the absence of any donor useful for polymerizing olefins.

### BACKGROUND OF THE INVENTION

While Ziegler-Natta catalysts are a mainstay for polyolefin manufacture, single-site (metallocene and non-metallocene) catalysts represent the industry's future. These catalysts are often more reactive than Ziegler-Natta catalysts, and they produce polymers with improved physical properties. The improved properties include controlled molecular weight distribution, reduced low molecular weight extractables, enhanced incorporation of alpha-olefin comonomers, lower polymer density, controlled content and distribution of long-chain branching, and modified melt rheology and relaxation characteristics.

Traditional metallocenes incorporate one or more cyclopentadienyl (Cp) or Cp-like anionic ligands such as indenyl, fluorenyl, or the like, that donate pi-electrons to the transition metal. Non-metallocene single-site catalysts, including ones that capitalize on the chelate effect, have evolved more recently. Examples are the bidentate 8-quinolinoxy or 2-pyridinoxy complexes of Nagy et al. (see U.S. Pat. No. 5,637,660), the late transition metal bisimines of Brookhart et al. (see Chem. Rev. 100 (2000) 1169), and the diethylenetriamine-based tridentate complexes of McConville et al. or Shrock et al. (e.g., U.S. Pat. Nos. 5,889,128 and 6,271,323).

All these catalyst systems are mainly based on organometallic complexes that have to be synthesized and purified before the use and that sometimes are not stable for long time.

Otherwise these catalyst system are based on alumoxanes that are quite expensive. The applicant now found a catalyst system simply to prepare and that do not require expensive organic compounds.

### SUMMARY OF THE INVENTION

The invention relates to catalyst system useful for polymerizing olefins. The catalysts comprise a Zirconium compound, an activator, and a support. The catalysts can be produced easily to synthesize and they offer polyolefin manufacturers good activity and the ability to make high-molecular-weight ethylene copolymers that have little or no long-chain branching.

### DETAILED DESCRIPTION OF THE INVENTION

An object of the present invention is a catalyst system obtainable with a process comprising the following steps:
i) contacting a Zirconium compound of formula (I)

ZrX₄ (I)
wherein X, equal to or different from each other, is a halogen atom, a R, OR, SR, NR₂ or PR₂ group wherein R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radical; or two X groups can be joined together to form a divalent R′ group wherein R′ is a C₁-C₂₀-alkylidene, C₆-C₂₀-arylidene, C₇-C₂₀-alkylarylidene, or C₇-C₂₀-arylalkylidene divalent radical optionally containing heteroatoms belonging to groups 13-17 of the Periodic Table of the Elements; preferably X is a halogen atom or R group; more preferably X is halogen or a C₇-C₄₀-alkylaryl radical such as benzyl radical; with
one or more boron compounds having Lewis acidity wherein the molar ratio between the boron compound and the compound of formula (I) ranges from 0.9 to 100; preferably from 0.9 to 10; more preferably from 0.9 to 5;
ii) adding the reaction mixture obtained in step i) to a support.

Preferably the catalyst system is not treated with alumoxanes.

Optionally the catalyst system object of the present invention can be treated before the use with organo-aluminium compound of formula HⱼAlU₃₋ⱼ or HⱼAl₂U₆₋ⱼ, where the U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or C₇-C₂₀-arylalkyl radicals, optionally containing silicon or germanium atoms, with the proviso that at least one U is different from halogen, and j ranges from 0 to 1, being also a non-integer number.

Boron compounds having Lewis acidity include organoboranes, organoboronic acids, organoborinic acids, and the like. Specific examples include lithium tetrakis(pentafluorophenyl)borate, anilinium tetrakis(pentafluorophenyl)-borate, trityl tetrakis(pentafluorophenyl)borate (“F20”), tris(pentafluorophenyl)-borane (“F15”), triphenylborane, tri-n-octylborane, bis(pentafluorophenyl)borinic acid, pentafluorophenylboronic acid, and the like. These and other suitable boron-containing activators are described in U.S. Pat. Nos. 5,153,157, 5,198,401, and 5,241,025, the teachings of which are incorporated herein by reference. Preferably trityl tetrakis(pentafluorophenyl)borate (“F20”) is used.

In step (ii) the catalyst systems obtainable with the process of the present invention are supported on a support; preferably the support is an inorganic oxide such as silica, alumina, silica-alumina, magnesia, titania, zirconia, clays, zeolites, or the like. Silica is preferred. When silica is used, it preferably has a surface area in the range of 10 to 1000 m²/g, more preferably from 50 to 800 m²/g and most preferably from 200 to 700 m²/g.

Preferably, the pore volume of the silica is in the range of 0.05 to 4.0 mL/g, more preferably from 0.08 to 3.5 mL/g, and most preferably from 0.1 to 3.0 mL/g Preferably, the average particle size of the silica is in the range of 1 to 500 microns, more preferably from 2 to 200 microns, and most preferably from 2 to 45 microns. The average pore diameter is typically in the range of 5 to 1000 angstroms, preferably 10 to 500 angstroms, and most preferably 20 to 350 angstroms.

The support is preferably treated thermally, chemically, or both prior to use by methods well known in the art to reduce the concentration of surface hydroxyl groups. Thermal treatment consists of heating (or “calcining”) the support in a dry atmosphere at elevated temperature, preferably greater than 100° C., and more preferably from 150 to 800° C., prior to use. A variety of different chemical treatments can be used, including reaction with organo-aluminum, -magnesium, -silicon, or -boron compounds. See, for example, the techniques described in U.S. Pat. No. 6,211,311, the teachings of which are incorporated herein by reference.

With the catalyst system of the present invention it is possible to polymerize alpha-olefins in high yield to obtain polymers having high molecular weight. Thus a further object of the present invention is a process for polymerizing one or more alpha olefins of formula CH₂═CHT wherein T is hydrogen or a C₁-C₂₀ alkyl radical comprising the step of contacting said alpha-olefins of formula CH₂═CHT under polymerization conditions in the presence of the catalyst system described above.

Preferred α-olefins are ethylene, propylene, 1-butene, 1-hexene, 1-octene.

The catalyst system of the present invention is particularly fit for the polymerization of ethylene or copolymerization of ethylene and propylene, 1-butene, 1-hexene and 1-octene.

Thus a further object of the present invention is a process for polymerizing ethylene and optionally one or more alpha olefins selected from propylene, 1-butene, 1-hexene and 1-octene comprising the step of contacting ethylene and optionally said alpha-olefins under polymerization conditions in the presence of the catalyst system described above.

Many types of olefin polymerization processes can be used. Preferably, the process is practiced in the liquid phase, which can include slurry, solution, suspension, or bulk processes, or a combination of these. High-pressure fluid phase or gas phase techniques can also be used. In a preferred olefin polymerization process, a supported catalyst of the invention is used. The polymerizations can be performed over a wide temperature range, such as −30° C. to 280° C. A more preferred range is from 30° C. to 180° C.; most preferred is the range from 60° C. to 100° C. Olefin partial pressures normally range from 15 psig to 50,000 psig. More preferred is the range from 15 psig to 1000 psig.

The invention includes a high-temperature solution polymerization process. By “high-temperature,” we mean at a temperature normally used for solution polymerizations, i.e., preferably greater than 130° C., and most preferably within the range of 135° C. to 250° C.

The following examples merely illustrate the invention. Those skilled in the art will recognize many variations that are within the spirit of the invention and scope of the claims.

### EXAMPLES

All intermediate compounds and complexes synthesized give satisfactory ¹H NMR spectra consistent with the structures indicated.

### Catalyst Preparation

ZrCl₄ (0.11 mmol) in 2 mL of toluene is contacted with trityl tetrakis(pentafluorophenyl)borate (0.14 mmol zirconium/boron ration 1.29) and the mixture is stirred for 30 min. The mixture is added to Davison 948 silica (0.5 g, calcined 6 h at 600° C.), and the resulting free flowing powder is to polymerize ethylene as described below.

### Ethylene Polymerization

A reactor is charged with isobutane (1 L), 1-butene (100 mL), triisobutylaluminum (TIBAL) (1 mL of 1M solution; scavenger). A portion of catalyst indicated in table 1 is treated with an amount of trisobutylaluminum (1M solution) indicated in table 1. The resulting catalyst is added to start the reaction. Polymerization continues at 70° C. for 1 hour, supplying ethylene on demand to maintain the 15 bar partial pressure. The polymerization is terminated by venting the reactor, resulting in white, uniform polymer powder. The polymerization results are indicated in table 1.

TABLE 1

| | Metal | Supp | TIBAL | Activity, | Branches/ | | |
|---|---|---|---|---|---|---|---|
| Ex. | source | cat. G | 1M ml | kg/mol/h | 1000 C. | MI2 | Er |
| 1 | ZrCl₄ | 0.150 | 0.03 | 4499 | 7.4 | 0.20 | 8.91 |

We claim:

1. A catalyst system obtainable with a process comprising the following steps:
i) contacting a Zirconium compound of formula (I)
ZrX₄ (I)
wherein X, equal to or different from each other, is a halogen atom, a R, OR, SR, NR₂ or PR₂ group wherein R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radical; or two X groups can be joined together to form a divalent R′ group wherein R′ is a C₁-C₂₀-alkylidene, C₆-C₂₀-arylidene, C₇-C₂₀-alkylarylidene, or C₇-C₂₀-arylalkylidene divalent radical optionally containing heteroatoms belonging to groups 13-17 of the Periodic Table of the Elements; with
one or more boron compounds having Lewis acidity wherein the molar ratio between the boron compound and the compound of formula (I) ranges from 0.9 to 100;
ii) adding the reaction mixture obtained in step i) to a support.

2. The catalyst system according to claim 1 treated before the use with organo-aluminium compound of formula HⱼAlU₃₋ⱼ or HⱼAl₂U₆₋ⱼ, where the U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or C₇-C₂₀-arylalkyl radicals, optionally containing silicon or germanium atoms, with the proviso that at least one U is different from halogen, and j ranges from 0 to 1, being also a non-integer number.

3. The catalyst system according to claim 1 wherein the boron compounds having Lewis acidity are selected from organoboranes, organoboronic acids, organoborinic acids

4. The catalyst system according to claim 1 wherein the support is selected from silica, alumina, silica-alumina, magnesia, titania, zirconia, clays, zeolites.

5. A process for polymerizing one or more alpha olefins of formula CH₂═CHT wherein T is hydrogen or a C₁-C₂₀ alkyl radical comprising the step of contacting said alpha-olefins of formula CH₂═CHT under polymerization conditions in the presence of the catalyst system of claim 1.

6. The polymerization process according to claim 1 fro the polymerization of ethylene and optionally one or more alpha olefins selected from propylene, 1-butene, 1-hexene and 1-octene comprising the step of contacting ethylene and optionally said alpha-olefins under polymerization conditions in the presence of the catalyst system of claim 1.
